(19) United States
(12) Patent Application Publication
(10) Pub. No.: US 2024/0111296 A1
(43) Pub. Date: Apr. 4, 2024

(54) DRIVING APPARATUS AND CONTROL METHOD THEREOF

(71) Applicant: SEMES CO., LTD., Cheonan-si (KR)

(72) Inventor: Ji-Wook KWON, Hanam-si (KR)

(73) Assignee: SEMES CO., LTD., Cheonan-si (KR)

(21) Appl. No.: 18/191,175

(22) Filed: Mar. 28, 2023

(30) Foreign Application Priority Data
Sep. 29, 2022 (KR) 10-2022-0124553

(51) Int. Cl. G05D 1/02; G06V 10/75; G06V 20/50; G08G 1/16

(52) U.S. Cl. CPC G05D 1/0236; G05D 1/0214; G06V 10/751; G06V 20/50; G08G 1/16

(57) ABSTRACT

The inventive concept provides a driving apparatus. The driving apparatus includes a main body; a driving unit configured to provide a driving force so the main body may drive; a marker output unit configured to irradiate a marker in a predetermined driving direction of the main body; an image acquisition unit configured to acquire a marker image by imaging the marker which is irradiated; and a determination unit for determining whether a risk factor of the predetermined driving direction exists from the marker image which is acquired from the image acquisition unit.

### CROSS-REFERENCE TO RELATED APPLICATIONS

A claim for priority under 35 U.S.C. § 119 is made to Korean Patent Application No. 10-2022-0124553 filed on Sep. 29, 2022, in the Korean Intellectual Property Office, the entire contents of which are hereby incorporated by reference.

### TECHNICAL FIELD

Embodiments of the inventive concept described herein relate to a driving apparatus and a control method thereof.

### BACKGROUND

In general, in an autonomous driving apparatus such as a robot or an unmanned vehicle, it is necessary to detect an obstacle at a front or height difference on a floor surface when moving to prevent a collision or an overturning. For a detection of such obstacles or steps, a method using a LIDAR (Light Detection and Ranging) sensor, a method using a near-infrared distance sensor or an ultrasonic sensor, a method of detecting a floor using a 3D camera or the like, and a method of setting a robot's prohibited entry area by editing a map, etc is used.

However, because LIDAR sensors are expensive components, a manufacturing price of the autonomous driving apparatus inevitably increases, which hinders a popularization of the autonomous driving apparatus. The classic method using the near-infrared distance sensor has a risk of overturning due to a delay in response of the autonomous driving apparatus when driving at a high speed, and is likely to be damaged or degraded due to foreign substances depending on a floor condition. In addition, the method of detecting the floor with a 3D camera has a disadvantage in that there is a high probability of a malfunction due to a noise generation in a limited area. In addition, the method of setting a prohibited area using the map has a problem in that it cannot be used if a position tracking error of the autonomous driving apparatus occurs.

### SUMMARY

Embodiments of the inventive concept provide a driving apparatus and a control method thereof for simultaneously detecting an obstacle in a front and a floor surface height difference.

Embodiments of the inventive concept provide a driving apparatus and a control method thereof for preventing a collision with an operator in a moving process.

The technical objectives of the inventive concept are not limited to the above-mentioned ones, and the other unmentioned technical objects will become apparent to those skilled in the art from the following description.

The inventive concept provides a driving apparatus. The driving apparatus includes a main body; a driving unit configured to provide a driving force so the main body may drive; a marker output unit configured to irradiate a marker in a predetermined driving direction of the main body; an image acquisition unit configured to acquire a marker image by imaging the marker which is irradiated; and a determination unit for determining whether a risk factor of the predetermined driving direction exists from the marker image which is acquired from the image acquisition unit.

In an embodiment, the marker output unit irradiates a visible laser or a light.

In an embodiment, the marker output unit outputs an arrow with a direction indicating the predetermined driving direction to a bottom surface of the predetermined driving direction.

In an embodiment, the marker output unit irradiates the marker in a downwardly inclined direction toward the bottom surface of the predetermined driving direction.

In an embodiment, the determination unit determines whether the risk factor exists in the predetermined driving direction by storing a reference image of the marker irradiated to the bottom surface which does not have the risk factor, and comparing the marker image acquired from the image acquisition unit with the reference image.

In an embodiment, the driving apparatus further includes a control unit configured to control the driving unit to stop a driving, avoid the risk factor, or decrease a driving speed, if it is determined that the risk factor exists by the determination unit.

In an embodiment, the risk factor includes an obstacle or a height difference.

In an embodiment, the control unit controls the driving unit to stop a driving or to avoid the obstacle if the risk factor is an obstacle.

In an embodiment, the control unit controls the driving unit to stop a driving or to decrease a driving speed according to a distance between the height difference if the risk factor is a height difference.

In an embodiment, the marker is an arrow shape having a direction indicating the predetermined driving direction.

The inventive concept provides a driving apparatus control method. The driving apparatus control method includes irradiating a marker to a predetermined driving direction; imaging the marker irradiated to acquire the marker image; and determining whether a risk factor exists in the predetermined driving direction from the marker image which is acquired.

In an embodiment, the determining whether the risk factor exists includes determining whether the risk factor of the predetermined driving direction exists by comparing a reference image of the marker which is irradiated to a bottom surface without the risk factor with the marker image.

In an embodiment, the driving apparatus control method further includes: controlling the driving unit of the driving apparatus to stop a driving of the driving apparatus or to avoid an obstacle if the risk factor is determined to be an obstacle at the determining whether the risk factor exists.

In an embodiment, the driving apparatus control method further includes: controlling the driving unit of the driving apparatus to stop a driving of the driving apparatus or to decrease a driving speed according to a distance between the height difference if the risk factor is determined to be a height difference at the determining whether the risk factor exists.

In an embodiment, the marker is provided by a visible laser or a light which is output from the marker output unit installed at the driving apparatus.

In an embodiment, the marker is downwardly inclined toward a bottom surface of the predetermined driving direction.

The inventive concept provides a driving apparatus. The driving apparatus includes a main body having a loader for loading an object; a driving unit configured to have a driving wheel equipped at a bottom of the main body and a driving unit for driving the driving wheel; a marker output unit equipped at a front of the main body and configured to irradiate a marker to a predetermined driving direction of the main body; an image acquisition unit equipped at a front of the main body and configured to image the marker which is irradiated and to acquire a marker image; a determination unit configured to determine whether a risk factor exists of the predetermined driving direction from the marker image acquired from the image acquisition unit; and a control unit configured to control the driving unit based on whether the risk factor exists.

In an embodiment, the determination unit determines whether the risk factor of the predetermined driving direction exists by storing a reference image of the marker which is irradiated to a bottom surface which does not have the risk factor, and comparing the marker image which is acquired from the image acquisition unit with the reference image.

In an embodiment, the control unit controls the driving unit to stop driving or to avoid the risk factor or to decrease a driving speed if the determination unit determines that the risk factor exists.

In an embodiment, the marker output unit is provided to irradiate a visible laser or a light to a bottom surface of the predetermined driving direction, and the marker is an arrow shape with a direction of the predetermined driving direction.

According to an embodiment of the inventive concept, by detecting a floor environment using a marker irradiated on a floor, it is possible to prevent an accident of being overturned if a driving apparatus enters an open grating floor environment or stairs, etc for a repair or a replacement of an equipment within a line.

According to an embodiment of the inventive concept, a safety of a driving apparatus and an operator may be ensured by making a driving direction of the driving apparatus aware to surrounding operators (walkers).

The effects of the inventive concept are not limited to the above-mentioned ones, and the other unmentioned effects will become apparent to those skilled in the art from the following description.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a perspective view illustrating an autonomous driving apparatus according to an embodiment of the inventive concept.

FIG. 2 is a side view of the autonomous driving apparatus shown in FIG. 1.

FIG. 3 is a plan view of the autonomous driving apparatus shown in FIG. 1.

FIG. 4 illustrates various markers.

FIG. 5 is a view comparing a marker image obtained by imaging a marker irradiated to a stepped portion formed on the floor surface with a reference image.

FIG. 6 is a view comparing the marker image obtained by imaging a marker irradiated on an obstacle with the reference image.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

When the term “same” or “identical” is used in the description of example embodiments, it should be understood that some imprecisions may exist. Thus, when one element or value is referred to as being the same as another element or value, it should be understood that the element or value is the same as the other element or value within a manufacturing or operational tolerance range (e.g., ±10%).

When the terms “about” or “substantially” are used in connection with a numerical value, it should be understood that the associated numerical value includes a manufacturing or operational tolerance (e.g., ±10%) around the stated numerical value. Moreover, when the words “generally” and “substantially” are used in connection with a geometric shape, it should be understood that the precision of the geometric shape is not required but that latitude for the shape is within the scope of the disclosure.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

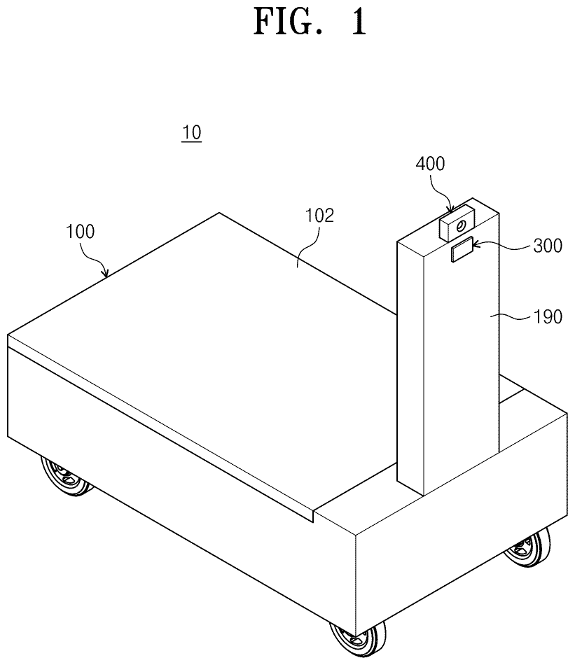

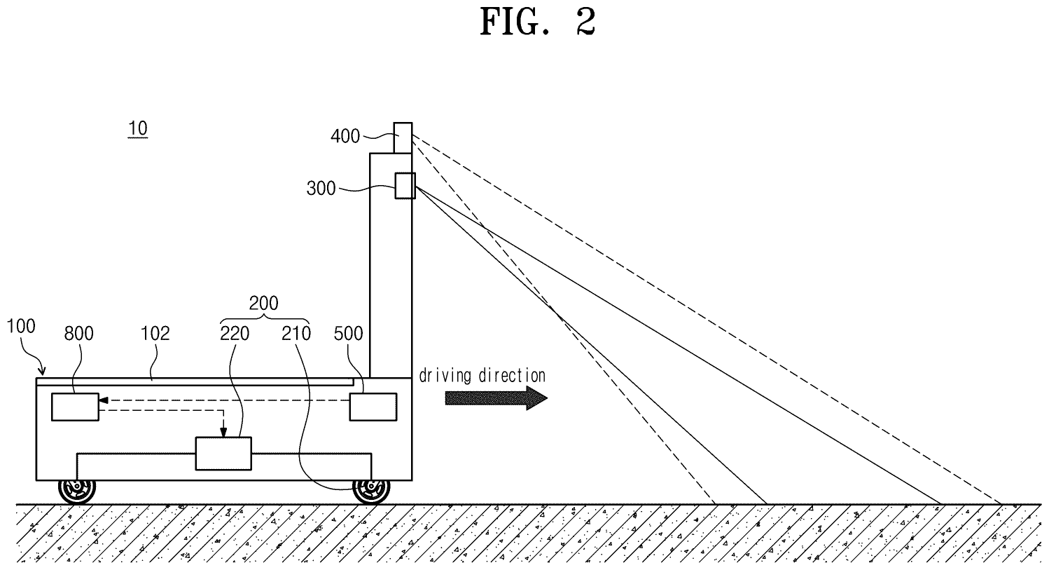

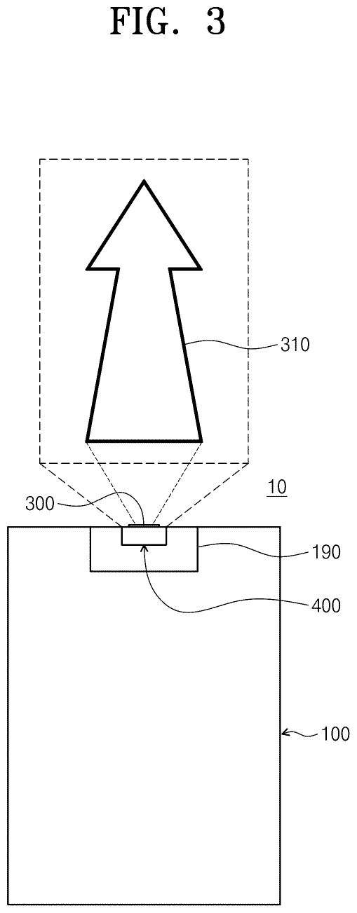

FIG. 1 is a perspective view illustrating an autonomous driving apparatus according to an embodiment of the inventive concept, FIG. 2 is a side view of the autonomous driving apparatus illustrated in FIG. 1, and FIG. 3 is a plan view of the autonomous driving apparatus illustrated in FIG. 1.

The autonomous driving apparatus 10 of the inventive concept is a comprehensive concept including a mobile robot, an unmanned ground vehicle (UGV), an automated guided vehicle (AGV), an autonomous vehicle, a humanoid robot, and a service guide robot.

Referring to FIG. 1 to FIG. 3, the autonomous driving apparatus 10 may move along a given driving path. In this case, the driving path may be a predetermined path, or may be an arbitrary path or a selected path between a departure point and a destination.

The autonomous driving apparatus 10 includes a main body 100. The autonomous driving apparatus 10 transfers an object to be transferred to the destination (transfer place). The object to be transferred may be, for example, a single item, or a combination of a plurality of items such as an object to be stored and a container for storing the object to be stored. To this end, the main body 100 may include a tray loading table 102 for transporting a tray of the object to be transferred, or a robot arm (not shown) for loading or unloading a predetermined tray or for performing a predetermined task.

The main body 100 is provided with a driving unit 200. The driving unit 200 may include driving wheels 210 (or an infinite orbit) provided at a bottom part of the main body as a component for moving the main body 100 and a driving unit 220 for driving the driving wheels 210. The driving unit 200 may perform steering, starting, stopping, and the like on the driving path. The driving unit 220 may be implemented as an electric motor according to a predetermined specification, and receives a power through a battery (not shown) mounted on the main body 100 to generate a driving force. The driving unit 200 may be controlled by the control unit 800.

The control unit 800 may be a vehicle control unit for controlling a driving of the autonomous driving apparatus 10. The control unit 800 may wirelessly communicate with a top control unit (not shown) through a wireless communication interface such as an LTE (Long Term Evolution), a Wireless LAN (Local Area Network), a WIFI (Wireless Fidelity), a Bluetooth, etc.

The control unit 800 may control a driving state including a driving state of the autonomous driving apparatus 10 according to a preset driving information. Here, the driving information may include a moving path information of the autonomous driving apparatus 10, and a current position information of the autonomous driving apparatus 10.

A head unit 190 having a predetermined height is provided in a driving direction of the main body 100. A marker output unit 300 and an image acquisition unit 400 may be provided at the head unit 190.

The marker output unit 300 is provided on a front surface of the head unit 190 and irradiates the marker 310 in a direction in a predetermined driving direction of the main body 100. The marker output unit 300 may be provided to irradiate a visible laser or a light. The marker output unit 300 may output a marker 310 in a downwardly inclined direction toward a bottom surface of the predetermined driving direction. The marker 310 may be a shape having a direction indicating the predetermined driving direction. In the inventive concept, the marker 310 is represented by an arrow shape, but is not limited thereto.

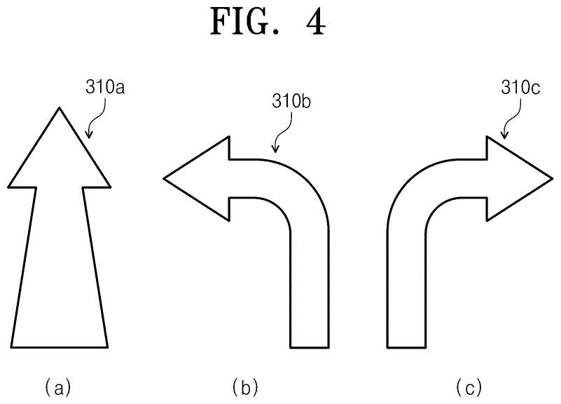

As illustrated in FIG. 4, the marker 310 irradiated from the marker output unit may include a straight line shape 310a having a straight line directionality, a left turn shape 310b having a left turn directionality, and a right turn shape 310c having a right turn directionality. The marker output unit 300 may selectively irradiate the straight line shape 310a, the left turn shape 310b, and the right turn shape 310c according to the predetermined driving direction.

The marker output unit 300 may prevent a collision by outputting the marker 310 to the bottom surface of the predetermined driving direction so that an operator (walker) around the autonomous driving apparatus 10 may recognize the predetermined driving direction of the autonomous driving apparatus 10 in advance.

Referring back to FIG. 1 to FIG. 3, the image acquisition unit 400 may be provided to the head unit 190. The image acquisition unit 400 may be provided to acquire a marker image by imaging the marker 310 irradiated from the marker output unit 300. For example, the image acquisition unit 400 may include a camera.

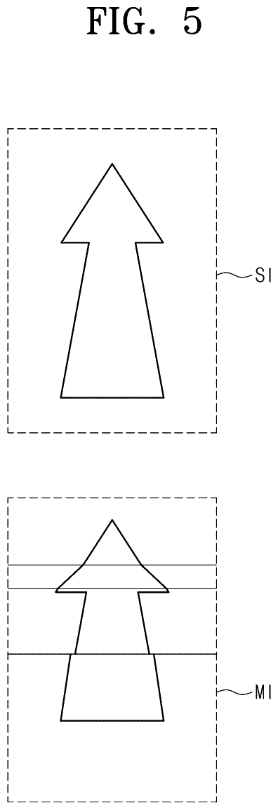

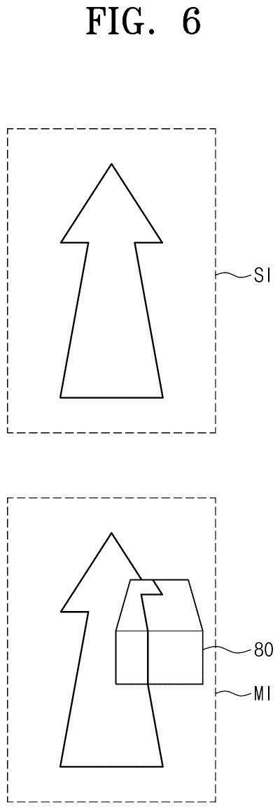

The autonomous driving apparatus 10 may include a determination unit 500. The determination unit 500 determines whether there is a risk factor in the predetermined driving direction from the marker image acquired from the image acquisition unit 400. In an embodiment, the determination unit 500 may store and learn a reference image of a marker irradiated on a floor surface without a risk factor. The determination unit 500 may compare the marker image MI (see FIG. 5 and FIG. 6) acquired from the image acquisition unit 400 with the reference image SI (see FIG. 5 and FIG. 6) to determine whether the predetermined driving direction is a risk factor. Here, the risk factor may include an obstacle and a floor surface height difference.

The determining unit 500 may check whether the shape of the marker image is changed or lost using a pattern matching method or a deep learning method, and through this, determine whether a risk factor exists. If the determination unit 500 determines that the risk factor exists, the control unit 800 may control the driving unit 200 to stop driving, to move and avoid the risk factor, or to decrease a driving speed.

A control method of the autonomous driving apparatus having the above-described configuration will be briefly described below.

The autonomous driving apparatus 10 irradiates the marker 310 in the predetermined driving direction. Then, the image acquisition unit 400 images the marker 310 and acquires the marker image. The acquired marker image is compared with a reference image irradiated to a bottom surface without the risk factor to determine whether the predetermined driving direction has a risk factor. If there is the risk factor in the predetermined driving direction, the driving unit 200 is controlled to stop a driving of the autonomous driving apparatus 10 or to avoid obstacles.

In the above-described embodiment, the method is described based on a series of steps, but the inventive concept is not limited to an order of steps, and some steps may occur in a different order or simultaneously from the steps described above. In addition, those skilled in the art will understand that steps shown in the flowchart are not exclusive, and that one or more steps in the flowchart may be deleted without affecting the scope of the inventive concept.

FIG. 5 is a view comparing the marker image obtained by imaging a marker irradiated on a floor surface height difference and a reference image, and if there exists a height difference in the predestined driving direction, the control unit 800 may control the driving unit 200 to stop driving or to decrease a driving speed according to a distance between the height difference.

FIG. 6 is a view comparing the marker image obtained by imaging a marker irradiated on the obstacle with the reference image, and if the obstacle 80 exists in the predetermined driving direction, the control unit 800 may control the driving unit 200 to stop driving or to avoid the obstacle.

In this way, the control unit 800 of the autonomous driving apparatus 10 may prevent a collision and an overturning accident with the obstacle through an emergency braking and avoidance driving when risk factors, i.e., an obstacle and a height difference, are present on the driving path.

The effects of the inventive concept are not limited to the above-mentioned effects, and the unmentioned effects can be clearly understood by those skilled in the art to which the inventive concept pertains from the specification and the accompanying drawings.

Although the preferred embodiment of the inventive concept has been illustrated and described until now, the inventive concept is not limited to the above-described specific embodiment, and it is noted that an ordinary person in the art, to which the inventive concept pertains, may be variously carry out the inventive concept without departing from the essence of the inventive concept claimed in the claims and the modifications should not be construed separately from the technical spirit or prospect of the inventive concept.

What is claimed is:

1. A driving apparatus comprising:
a main body;
a driving unit configured to provide a driving force so the main body may drive;
a marker output unit configured to irradiate a marker in a predetermined driving direction of the main body;
an image acquisition unit configured to acquire a marker image by imaging the marker which is irradiated; and
a determination unit for determining whether a risk factor of the predetermined driving direction exists from the marker image which is acquired from the image acquisition unit.

2. The driving apparatus of claim 1, wherein the marker output unit irradiates a visible laser or a light.

3. The driving apparatus of claim 2, wherein the marker output unit outputs an arrow with a direction indicating the predetermined driving direction to a bottom surface of the predetermined driving direction.

4. The driving apparatus of claim 2, wherein the marker output unit irradiates the marker in a downwardly inclined direction toward the bottom surface of the predetermined driving direction.

5. The driving apparatus of claim 2, wherein the determination unit determines whether the risk factor exists in the predetermined driving direction by storing a reference image of the marker irradiated to the bottom surface which does not have the risk factor, and comparing the marker image acquired from the image acquisition unit with the reference image.

6. The driving apparatus of claim 5, further comprising a control unit configured to control the driving unit to stop a driving, avoid the risk factor, or decrease a driving speed, if it is determined that the risk factor exists by the determination unit.

7. The driving apparatus of claim 5, wherein the risk factor includes an obstacle or a height difference.

8. The driving apparatus of claim 5, wherein the control unit controls the driving unit to stop a driving or to avoid the obstacle if the risk factor is an obstacle.

9. The driving apparatus of claim 5, wherein the control unit controls the driving unit to stop a driving or to decrease a driving speed according to a distance between the height difference if the risk factor is a height difference.

10. The driving apparatus of claim 1, wherein the marker is an arrow shape having a direction indicating the predetermined driving direction.

11. A driving apparatus control method comprising:
irradiating a marker to a predetermined driving direction;
imaging the marker irradiated to acquire the marker image; and
determining whether a risk factor exists in the predetermined driving direction from the marker image which is acquired.

12. The driving apparatus control method of claim 11, wherein the determining whether the risk factor exists includes determining whether the risk factor of the predetermined driving direction exists by comparing a reference image of the marker which is irradiated to a bottom surface without the risk factor with the marker image.

13. The driving apparatus control method of claim 12, further comprising:
controlling the driving unit of the driving apparatus to stop a driving of the driving apparatus or to avoid an obstacle if the risk factor is determined to be an obstacle at the determining whether the risk factor exists.

14. The driving apparatus control method of claim 12, further comprising:
controlling the driving unit of the driving apparatus to stop a driving of the driving apparatus or to decrease a driving speed according to a distance between the height difference if the risk factor is determined to be a height difference at the determining whether the risk factor exists.

15. The driving apparatus control method of claim 12, wherein the marker is provided by a visible laser or a light which is output from the marker output unit installed at the driving apparatus.

16. The driving apparatus control method of claim 12, wherein the marker is downwardly inclined toward a bottom surface of the predetermined driving direction.

17. A driving apparatus comprising:
a main body having a loader for loading an object;
a driving unit configured to have a driving wheel equipped at a bottom of the main body and a driving unit for driving the driving wheel;
a marker output unit equipped at a front of the main body and configured to irradiate a marker to a predetermined driving direction of the main body;
an image acquisition unit equipped at a front of the main body and configured to image the marker which is irradiated and to acquire a marker image;
a determination unit configured to determine whether a risk factor exists of the predetermined driving direction from the marker image acquired from the image acquisition unit; and
a control unit configured to control the driving unit based on whether the risk factor exists.

18. The driving apparatus of claim 17, wherein the determination unit determines whether the risk factor of the predetermined driving direction exists by storing a reference image of the marker which is irradiated to a bottom surface which does not have the risk factor, and comparing the marker image which is acquired from the image acquisition unit with the reference image.

19. The driving apparatus of claim 18, wherein the control unit controls the driving unit to stop driving or to avoid the risk factor or to decrease a driving speed if the determination unit determines that the risk factor exists.

20. The driving apparatus of claim 17, wherein the marker output unit is provided to irradiate a visible laser or a light to a bottom surface of the predetermined driving direction, and
the marker is an arrow shape with a direction of the predetermined driving direction.
